(19) United States
(12) Patent Application Publication
(10) Pub. No.: US 2018/0186102 A1
(43) Pub. Date: Jul. 5, 2018

(54) A PIPE FORMING ASSEMBLY AND METHOD OF USE

(71) Applicant: WNR SYSTEMS PTE. LTD., Singapore (SG)

(72) Inventor: Wayne BARRETT, Surfers Paradise, Queensland (AU)

(21) Appl. No.: 15/740,277

(22) PCT Filed: Jun. 27, 2016
(86) PCT No.: PCT/AU2016/050547

§ 371 Date: Dec. 27, 2017

(30) Foreign Application Priority Data
Jun. 30, 2015 (AU) 2015902547

(51) Int. Cl. B29C 70/28; F16L 1/038

(52) U.S. Cl. CPC B29C 70/28; B29L 2023/22; F16L 1/038

(57) ABSTRACT

A pipe forming assembly and method of use is provided for forming a continuous length of pipe. In particular, the present invention concerns a pipe forming assembly including: a former; at least one applicator for applying material about the former, the at least one applicator being movable relative to the former while applying material to form the pipe; and a carriage for conveying the former and the at least one applicator along a surface for forming a continuous length of pipe.

### TECHNICAL FIELD

The present invention relates to a pipe forming assembly and a method of use, in particular an assembly and method of forming a continuous length of pipe.

### BACKGROUND

Wound pipe, also known as filament wound pipe, is pipe that is fabricated through a process called filament winding. The process involves winding material over a male mould, mandrel or former (hereafter referred to as a former). The material is usually filamentous, commonly carbon, glass or aramid fibre and is impregnated with a resin before winding (“wet winding”), pre-impregnated (“dry winding”) or post-impregnated. The former is completely covered to a desired thickness with the material, which is then allowed to cure and solidify. Once the material has cured, the former is removed leaving a portion of wound pipe.

Wound pipes offer many advantages over conventional pipes including: corrosion resistance; light weight; strength; higher operating temperatures; and electrical and thermal insulation. Due to these advantages, wound pipes have many applications, and, in particular, are used in the transmission of oil, gas, chemicals and industrial wastes.

Typically, wound pipe is made in factories by continuous filament winding machines and then transported to a site of use where discrete lengths of wound pipe are fitted together to a desired length. Some of the disadvantages of this process are:
the pipes are bulky to transport from a factory to a construction site;
the pipes require fitting together at the site of use, which is both a labour intensive and costly process involving transporting the pipes, unloading the pipes, placing the pipes into a desired location and then joining the pipes together; and
the numerous joints where the discrete lengths of pipe are joined together lead to a weakening in the overall structural integrity of the pipe.

The applicant has addressed one or more of the aforementioned disadvantages or problems by virtue of their pipe forming apparatus and process as disclosed in Australian Patent Application No. 2012216495, which is herein incorporated by reference in its entirety. However, the applicant has recognised that further refinements of the invention are required in order to improve the performance of the pipe forming apparatus and process.

### SUMMARY OF INVENTION

Embodiments of the present invention provide an improved pipe forming assembly and a method of use, which may at least partially overcome at least one of the problems or disadvantages mentioned above or which may provide the public with a useful or commercial choice.

According to a first aspect of the present invention, there is provided a pipe forming assembly for forming a continuous length of pipe including:

a former;

at least one applicator for applying material about the former, said at least one applicator being movable relative to the former while applying material to form the pipe; and

a carriage for carrying the former and the at least one applicator along a surface when forming the continuous length of pipe with the applicator.

Preferably, the assembly may include at least two applicators for applying material about the former.

Advantageously, the pipe forming assembly and method of use of the present invention allows the formation of pipe on site of any desired length and orientation. Moreover, embodiments of the present invention in which the assembly includes more than one applicator allow the rapid formation of pipe of any desired thickness and the formation of pipe from more than one material. As such, the assembly is capable of forming pipe having a particular lining or coating.

The assembly may be of any suitable size, shape and construction and formed from any suitable material or materials. Typically, the assembly may be formed from materials capable of withstanding the strains and stresses associated with being operated in an external environment, particularly a harsh external environment, such as, e.g., environments with extreme temperatures, particularly high temperatures, and wet or dusty conditions.

The applicator may preferably be in the form of a winding apparatus configured to wind material about the former for forming pipe, preferably for winding the material under tension about the former.

The material may be any suitable material capable of being applied or wound about the former and forming pipe. Typically, the material may be a fibrous material. Preferably, the material is a fibrous material that solidifies once impregnated with a thermosetting composition and allowed to cure. In some embodiments, a specific type of material may be used due to its particular properties, such as, e.g., potability, heat resistance, U.V. resistance and/or anti-ballistic. Typically, the material may be glass fibre, carbon fibre, aramid fibre, boron fibre or any combination thereof. In preferred embodiments, the material may be a multiaxial fibrous material, such as, e.g., a triaxial or a quadraxial fibrous material.

The material may be wound about the former at any angle relative to the former (“wrap angle”). Preferably, the winding apparatus may be adjustable to adjust the wrap angle and vary the properties of any subsequently formed pipe. For example, a high wrap angle (i.e., between 75° and 85° relative to the former) may be selected to provide greater crush strength whereas a low wrap angle (also known as closed or helical; i.e., between 15° and 45° relative to the former) may be selected to provide greater tensile strength. Typically, the material may be helically applied or wound about the former at a wrap angle of between 30° and 85° relative to the former.

The material may be impregnated with the thermosetting composition just before being wound about the former (“wet wound”), or the material may be pre-impregnated (“dry wound”) or post-impregnated with the thermosetting composition.

Preferably, the material may be pre-impregnated with the thermosetting composition.

The thermosetting composition may include any suitable composition formulated to polymerise or “cure” once it has been wound together with the material about the former, preferably rapidly cure. In some embodiments, a specific type of thermosetting composition may be used due to its particular properties, such as, e.g., rapid cure, potability, heat resistance, fire retardant and/or U.V. resistance. Typically, the thermosetting composition may include an artificial resin. Preferably, the thermosetting composition will be a polyepoxide or epoxy resin, orthopthalic acid based resin, isopthalic acid based resin, dicyclopentadiene resin, epoxy vinyl ester resin or any other like resin.

The winding apparatus may include at least one roller and a roller support for supporting the at least one roller and orbiting the at least one roller about the former. The roller support may be of any suitable size, shape and construction. Typically, the roller support may support a plurality of rollers.

The roller support may be in the form of a frame configured to be mechanically driven about the former. The frame may include a first end frame member and a second end frame member. Each end frame member may encircle the former and be configured to rotate about the former. Rollers may extend between the first and second end frame members. Each roller may be configured to wind material about the former as the roller support rotates and the roller orbits about the former.

The roller support may be mechanically driven about the former in any suitable way. For example, in one embodiment, the roller support may be mechanically driven about the former by a rack and pinion drive system. In another embodiment, the roller support may be mechanically driven about the former by a belt drive system. In yet another embodiment, the roller support may be mechanically driven about the former by a power transmission system. Typically, one or both of the first and second frame members of the roller support may be mechanically driven about the former. Preferably, rotation of the roller support about the former may be automated.

The rollers may be of any suitable size, shape and construction to wind the material about the former. Likewise, the rollers may couple with the roller support in any suitable way. For example, each roller may permanently or releasably couple with the roller support, preferably releasably.

In some embodiments, the winding apparatus may include a feed roller (a “material reservoir”) in addition to the at least one roller, which may be configured to wind the material about the former and guide material being pulled from the feed roller.

In other embodiments, the at least one roller of the winding apparatus may be configured to guide and wind material about the former, the material being pulled from an external material reservoir.

In preferred embodiments, each roller of the winding apparatus may be a feed roller and may independently wind material about the former, preferably under tension.

The rollers may be arranged in the roller support in any suitable arrangement to orbit the former and wind material about the former. Typically, the rollers may be arranged within the roller support at any suitable angle relative to the former to achieve a desired wrap angle. As indicated above, preferably the angle of each roller relative to the former may be adjustable to alter the wrap angle as desired. The angle of each roller may be manually adjusted, e.g., by hand, or may be mechanically adjusted, such as, e.g., by one or more servomechanisms or linear actuators (e.g., a hydraulic or pneumatic actuator). If mechanically adjusted, a user may input a desired wrap angle through a user interface for controlling the one or more servomechanisms or linear actuators. In preferred embodiments, the angle of the rollers may be adjusted whilst winding material about the former.

Each roller may preferably be formed from a material or materials that are inert or that will not react with the material being wound about the former. For example, in one embodiment, the rollers may be formed from stainless steel. In another embodiment, the roller may be formed from a composite material, such as, e.g., a thermoplastic composite. In a preferred embodiment, each roller may be formed from a high density foam core with a high performance composite outer layer that exhibits high strength, high rigidity and/or heat resistance, such as, e.g., a carbon-fibre or aramid fibre based composite material.

In some embodiments, the assembly may include a reservoir of the thermosetting composition for impregnating the material prior to being wound about the former (i.e., wet winding). The reservoir may be of any suitable size and shape and may be arranged relative to the rollers so that the material is at least partially immersed in the reservoir as it is pulled from the material reservoir or a feed roller prior to being wound about the former.

In other embodiments, the at least one roller of the winding apparatus may include perforations for applying the thermosetting composition to the material as it is wound about the former. Preferably, the roller in these embodiments may be hollow and the thermosetting composition may be pumped into the roller to ensure the thermosetting composition is evenly secreted and applied to the material as it is pulled and wound by the roller about the former.

Typically, the thermosetting composition will be pumped into the roller via a feed pipe. The feed pipe may be supplied with the thermosetting composition from a suitably shaped and arranged reservoir located on the assembly. Preferably, the reservoir will be located in a position on the assembly where it will not be rotated or interfere with the winding apparatus.

In preferred embodiments and as indicated above, each roller may be a feed roller including pre-impregnated material. Advantageously, the inventor has found that the use of pre-impregnated material allows the assembly to be operated at higher operating speeds.

In some embodiments, the assembly may further include a loading arm for replacing rollers on the roller support once they are exhausted of material. The loading arm may be of any suitable size, shape and construction. The loading arm may have a first end pivotally mountable to the roller support, preferably at a location at or near a base of the roller support. The loading arm may have a second end pivotable between raised and lowered positions relative to the roller support. The second end of the loading arm may preferably include gripping means or a gripping unit for gripping and releasing rollers when moving rollers between the raised and lowered positions.

In use, the loading arm may move to the raised position to grip and remove an exhausted roller. The loading arm may then move to the lowered position to exchange the exhausted roller for a replacement roller before moving back to the raised position to fit the replacement roller to the roller support.

The loading arm may be moved between positions by any suitable means. For example, the loading arm may move between positions by manual means, e.g., by hand, or may be powered between positions by an electric, hydraulic, pneumatic or internal combustion motor.

Typically, the gripping means or gripping unit may include at tong or hand-like mechanism for gripping and releasing rollers. The gripping means or gripping unit, as with the loading arm, may be moveable between a gripping position and a release position by manual means, e.g., by hand, or may be powered between positions by an electric, hydraulic, pneumatic or internal combustion motor.

Preferably, the loading arm, including the gripping means or gripping unit, may be mechanically operated via a user interface for controlling the electric, hydraulic, pneumatic or internal combustion motor for moving the loading arm and the gripping means or gripping unit. In some embodiments, operation of the loading arm may be automated.

In one embodiment, the inventor envisages that the assembly may include a source of replacement rollers for the loading arm to exchange with exhausted rollers. In another embodiment, the inventor envisages that the loading arm may exchange exhausted rollers with an external source of replacement rollers, such as, e.g., a supply vehicle or bin or conveyor system positioned aside the assembly.

As indicated above, the assembly further includes a former. The former may be of any suitable length, diameter, shape and construction.

Typically, the former may have a length of between 5 and 40 metres, between 5 and 35 metres, between 5 and 30 metres, between 5 and 25 metres, between 5 and 20 metres, between 5 and 15 metres or between 5 and 10 metres.

The former may have any shaped cross-section suitably adapted to produce a wound pipe of similar shape. Typically, the former may have a circular cross-section or an elliptical cross-section.

Likewise, the diameter of the former may be of any value suitably adapted to allow the winding apparatus to rotate about it. Ultimately, the diameter of the former will determine the diameter of the wound pipe formed and the diameter of the former may be governed by the size of the rest of the assembly. Therefore, to produce wound pipe with a large diameter a suitably sized assembly will need to be used to wind material about a former with a suitably large diameter to produce the wound pipe.

As with the rollers, the former may be formed from or have a surface coating formed from a material or materials that are inert or that will not react with the material being wound about it. For example, in one embodiment, the former may be formed from stainless steel. In another embodiment, the former may be formed from a composite material such as, e.g., a thermoplastic composite. In a preferred embodiment, the former may be formed from a high density foam core with a high performance composite outer layer that exhibits high strength, high rigidity and/or heat resistance, such as, e.g., a carbon-fibre or aramid fibre based composite material.

The former may preferably have an adjustable circumference thereby allowing pipe of differing diameters to be formed on the same former, and to at least partially assist in dissociating the former from a portion of pipe, once cured. This may be achieved in any suitable way.

For example, in one embodiment, the former may include an internal bladder that may be inflated to increase the circumference of the former and deflated to decrease the circumference of the former.

In another embodiment, the former may include a radial segment capable of moving in a lateral direction relative to a remainder of the former to adjust the circumference of the former. For example, the radial segment may move inwards to increase the circumference of the former and move outwards to decrease the circumference of the former.

In yet another embodiment, the former may include a segment having a triangular cross-section (i.e., wedge-shaped) and moveable in a lateral direction relative to the remainder of the former to adjust the circumference of the former. For example, the segment may move inwards to decrease the circumference of the former and move outwards to increase the circumference of the former.

In use, the circumference of the former may be adjusted to expand once material is wound about the former and prior to curing of the material to form the pipe. Advantageously, the present inventor has found that expansion of the former prior to curing at least partially assists in placing the material wound about the former in a state of tension to at least partially enhance the quality of the subsequently formed pipe.

The former may be supported on the carriage of the assembly in any suitable way. For example, in some embodiments the former may be supported on the carriage by one or more former supports. The former supports may be located at any suitable locations on the carriage, such as, e.g., at or near one or both longitudinal ends of the carriage and/or at spaced intervals along a length of the carriage.

In other embodiments, each winding apparatus may further include one or more former supports. The former supports may be located on either or both sides of each winding apparatus and configured to support the former and move with the winding apparatus as it moves along the length of the former.

The former and the former supports may be connectable. This may involve a permanent or a releasable connection, preferably releasable.

The former and each former support may be connected to one another by a connecting mechanism or part of a connecting mechanism. The connecting mechanism may be part of the pipe forming assembly. Preferably, a first part of a connecting mechanism associated with the former may mate with or engage with a second part of the connecting mechanism associated with each former support.

The connecting mechanism may include a threaded connection, an interference fit (snap fit) connection or bayonet-type connection, for example. Preferably the connecting mechanism involves a male formation engaging a female formation. In one embodiment, the connecting mechanism comprises the former having a male formation that engages with a female formation of the former support. In another embodiment, the former has a female formation that engages with a male formation of the former support.

In some embodiments, the former support may include one or more rollers to assist in passage of the pipe from the former.

As indicated above, the winding apparatus may be movable relative to the former. This may be achieved in any suitable way that allows the winding apparatus to move along a length of the former while winding material about the former.

For example, in one embodiment, the carriage may include a rail and a base of the roller support may include one or more wheels or rollers for moving along the rail and thereby moving the roller support and the winding apparatus along the carriage relative to the former.

The rail may include any form of guided or directional conveyance. For example, the rail may include a track. The rail may be of any suitable size, shape and construction and may be formed from any suitable material or materials. Preferably, the rail may be of a size, shape and construction that allows movement of the winding apparatus along a longitudinal length of the carriage. More preferably, the rail may be of a size, shape and construction that prevents lateral movement or separation of the winding apparatus away from the rail and carriage.

In another embodiment, the winding apparatus may be moveable relative to the former by way of a rack and pinion system. The carriage may include one or more racks extending longitudinally along a length of the carriage atop the carriage, and the base of the roller support may include one or more pinions each engageable with a corresponding rack for moving the winding apparatus relative to the carriage and the former. As with the rail, each rack and pinion may be engageable in a way that allows movement of the winding apparatus along a longitudinal length of the carriage, preferably without lateral movement or separation of the winding apparatus away from the racks and carriage.

The winding apparatus may be moved relative to the carriage and the former by any suitable means. For example, the winding apparatus be moved by manual means, e.g., by hand, or may be mechanically moved by an electric, hydraulic, pneumatic or internal combustion motor. Preferably, mechanical movement of the winding apparatus relative to the former may be automated.

In some embodiments, the winding apparatus may further include a brake for slowing or stopping movement of the winding apparatus along the carriage relative to the former. The brake may be of any suitable size, shape and/or form known in the art.

In some embodiments, the winding apparatus may further include at least one clamp for temporarily clamping the winding apparatus to pipe formed about the former. The clamp may be of any suitable size, shape and/or form known in the art. Typically, the clamp may be a mechanical clamp, preferably powered by an electric, hydraulic, pneumatic or internal combustion motor.

In use, the clamp may at least partially assist in dissociating or removing pipe from the former. This will be described in detail below.

In preferred embodiments, the assembly may include at least two winding apparatuses. The at least two winding apparatuses may each be configured to rotate in a same direction or in opposed directions around or about the former.

For example, in one embodiment in which a single material type is being wound about the former, the respective winding apparatuses may each be configured to wind in a single direction about the former to hasten pipe formation. Advantageously, by winding material about the former in a common direction, the winding apparatuses may collaboratively each form a portion of pipe thereby hastening the formation of a continuous length of pipe. Preferably, each portion of pipe formed may at least partially overlap an adjacent portion of pipe formed or be at least partially overlapped by an adjacent portion of pipe formed.

In another embodiment, winding apparatuses may each wind a single material type about the former in opposed directions. In this embodiment, the winding apparatuses may each pass over the former thereby quickly achieving a continuous length of pipe of desired thickness without the need for each winding apparatus to make multiple passes over the former.

In yet another embodiment, the winding apparatuses may each wind different material types about the former in a common direction or opposed directions. For example, a first winding apparatus may wind a first material about the former whereas a second winding apparatus may wind a second material about the former over the first material. The first material may be a pipe forming material and the second material may be coating material. Conversely, the first material may be a lining material and the second material may be the pipe forming material.

The carriage may be of any suitable size and shape for carrying or conveying the winding apparatus and the former along a surface, preferably a ground surface. Likewise, the carriage may be formed from any suitable material or materials.

Typically, the carriage may serve as a platform upon which the former and the winding apparatus may rest and upon which the winding apparatus may move relative to the former.

Typically, the carriage may be formed of metal.

In some embodiments, the carriage may include a pair of longitudinally extending side frame members joined together by a plurality of transversely extending cross frame members. The frame members may be of tubular or solid construction, typically tubular with a substantially square-shaped cross-section. Typically, the various frame members of the carriage are permanently joined together using conventional welding techniques.

In some embodiments, the carriage may further include an upper panel upon which the former and the winding apparatus may rest.

The carriage may preferably have an elongate structure of suitable length to allow at least one winding apparatus to move along a length of the carriage while winding material about the former, preferably at least two winding apparatuses. For example, the carriage may have a length of between 5 and 40 metres, between 5 and 35 metres, between 5 and 30 metres, between 5 and 25 metres, between 5 and 20 metres, between 5 and 15 metres or between 5 and 10 metres.

The carriage may preferably include wheels or caterpillar tracks for moving the carriage (and conveying the winding apparatus and the former) along a surface. In preferred embodiments, the wheels or caterpillar tracks may be driven by an electric or internal combustion motor for propelling the carriage and thereby the assembly along a surface, preferably each wheel or track may be independently driven. The wheels or caterpillar tracks may be operated by a user interface, preferably operation of the wheels or caterpillar tracks may be automated.

In some embodiments, the carriage may include a self-levelling suspension system to assist in stabilising the assembly as it moves along the surface, particularly an uneven or rough surface.

The assembly may further include navigational unit for orientating and aligning the assembly to a desired path. The navigational unit may be of any form suitably adapted to orientate and align the assembly. Preferably, the navigational unit may be a global positioning satellite (‘GPS’) system. The GPS system may be located at any suitable position on the assembly. For example, the GPS system may be located at or near a front or a rear of the assembly.

The assembly may further include an enclosure suitably adapted to at least partially enclose the assembly. The enclosure may be of any suitable size, shape and configuration and may be formed from any suitable material or materials. The enclosure may preferably be adapted to provide a substantially dust-free and moisture-free enclosure for the assembly. Preferably, the enclosure may be translucent or transparent allowing visualisation of the winding apparatus within. Typically, the enclosure may be adapted to allow the winding apparatus of the assembly to operate freely. Preferably, the enclosure only partially encloses the assembly allowing formed pipe to extend through the enclosure.

In some embodiments, the assembly may further include a curing unit for curing the material once wound about the former. The curing unit may be of any size, shape and configuration and arranged relative to the winding apparatus to suitably cure the material once wound about the former.

In one embodiment, the curing unit may be located behind the winding apparatus such that freshly wound material is passed through the curing unit as the winding apparatus is moved relative to the carriage and the former.

In another embodiment, the curing unit may be located within the former such that freshly wound material is cured once it is wound about the former. In this embodiment, the former may or may not include perforations to assist the curing unit in curing the material.

The curing unit may cure the material with radiant energy, one or more heat exchangers, steam-based heating, or, preferably, microwave, infrared or ultraviolet electromagnetic radiation.

In some embodiments, the assembly may include a communication module for connecting the assembly to an external processing device, such as, e.g., a computer, tablet, smart phone, smart watch or PDA. The assembly may be connected to an external processing device in any suitable way.

For example, the communication module may be in the form of a port or access point (e.g., USB or mini-USB port) such that the assembly may be connected to an external processing device using a suitable cable.

For example, the communication module may be in the form of a wireless communication module, such as, e.g., a wireless network interface controller, such that the assembly may wirelessly connect to an external processing device through a wireless network (e.g., Wi-Fi (WLAN) communication, satellite communication, RF communication, infrared communication, or Bluetooth™).

In some embodiments, the assembly may further include a data-logging unit configured to keep a record of operating conditions, such as, e.g., environmental temperature, operating temperature, humidity, winding speed, wrap angle, length of pipe produced, curing time, speed of assembly along a surface, distance traveled by assembly along the surface, etc.). The data-logging unit may also keep a record of the quality of the pipe formed by taking photographs, preferably overhead photographs, and capturing ultrasound-based images of pipe formed at various time points. The data-logging unit may be accessed directly or indirectly, preferably indirectly (i.e., wirelessly).

The assembly may preferably include a user interface for controlling operation of the assembly. In some embodiments, the user interface may be located on the assembly and be accessed directly by an operator. In other embodiments, the user interface may be accessed indirectly by an external processing device, preferably wirelessly.

In some embodiments, the assembly may be connected to one or more other like assemblies, preferably serially connected.

The assemblies may be serially connected in any suitable way. This may involve a permanent or a releasable connection, preferably the latter. Likewise, this may involve a direct connection or an indirect connection, preferably a direct connection.

Each assembly may be connectable to one or more other like assemblies by a connecting mechanism or part of a connecting mechanism. The connecting mechanism or part of the connecting mechanism may be part of each assembly. Preferably, a first part of a connecting mechanism associated with a rear of a first assembly may mate with or engage with a second part of the connecting mechanism associated with a front of a second assembly.

The connecting mechanism may preferably be in the form of a hitch assembly. Preferably, the connecting mechanism may involve a male formation engaging a female formation. For example, in one embodiment the connecting mechanism may involve a male formation in the form of a tow ball or tow pin associated with a first assembly that engages with a female formation in the form of a tow ball or pin coupling associated with a second assembly. In another embodiment, the connecting mechanism may involve a male formation in the form of a pintle hook associated with a first assembly that engages with a female formation in the form of a lunette ring associated with a second assembly.

In one embodiment, the former from each assembly may be connectable with the former from each like assembly arranged serially.

In another embodiment, the serially connected assemblies may share a common former.

In some embodiments, the winding apparatus and the former of the assembly may be configured to be pivotable between horizontal and vertical operating positions. The winding apparatus and the former may be configured to pivot in any suitable way.

For example, in one embodiment, at least a portion of the carriage, including the rail or the racks along which the winding apparatus moves relative to the former, may be pivotally coupled to a remaining portion of the carriage at a first end with an opposed second end of the carriage being pivotable between the horizontal and vertical operating positions. The opposed second end may include a linear actuator (i.e., a ram) for moving the former, the winding apparatus and the at least a portion of the carriage between the horizontal and vertical operating positions. The linear actuator may be powered by an electric, hydraulic, pneumatic or internal combustion motor.

Advantageously, vertical operation of the assembly allows the formation on site of a continuous length of pipe for lining bore holes, air ducts, air purification towers and the like. By forming a continuous length of pipe, the present invention eliminates points of weakness, such as, e.g., joints between discrete lengths of pipe. Additionally, by eliminating joints, the process of lining bore holes, air ducts, air purification towers and the like is simplified as there is no longer any requirement to provide clearance for joining flanges and the like between discrete lengths of pipe and the edge of a bore hole, air duct, air purification tower or the like.

According to a second aspect of the present invention, there is provided a former for use with or when used with the pipe forming assembly of the first aspect, said former configured to have material applied about it for forming a pipe.

According to a third aspect of the present invention, there is provided an applicator for use with or when used with the pipe forming assembly of the first aspect, said applicator configured to apply material about the former of the assembly unit for forming a pipe.

According to a fourth aspect of the present invention, there is provided a carriage for use with or when used with the pipe forming assembly of the first aspect, said carriage configured to convey the former and the applicator of the assembly along a surface for forming a continuous length of pipe.

According to a fifth aspect of the present invention, there is provided a pipe forming assembly including at least two of the pipe forming assembly as defined in the first aspect arranged in series, each pipe forming assembly being configured to apply material about the former.

According to a sixth aspect of the present invention, there is provided a method of forming a continuous length of pipe, said method including:

applying material with at least one applicator about a former and moving the at least one applicator relative to the former while applying the material to form the pipe; and

moving the at least one applicator and the former along a surface while applying the material to form the continuous length of pipe.

The method may include one or more features or characteristics of the assembly, the former, the applicator and the carriage as hereinbefore described.

For example, the method may be carried out by the pipe forming assembly according to the first or fifth aspect of the present invention.

Typically, said applying may include at least two applicators applying material about the former. Preferably, each applicator may be in the form of a winding apparatus and said applying material may include winding at least one type of material about the former.

In some embodiments, said applying may include the applicator moving at least once along a length of the former while applying material about the former. Depending on the desired density and thickness of the pipe, said applying may include the applicator making numerous passes along a length of the former.

Preferably, the method may further include pausing between said applying and said moving to allow for the material applied about the former to cure and form the pipe.

Typically, said moving may further include dissociating the former from the pipe and moving the applicator and the former relative to the pipe formed.

In one embodiment, said moving may include collapsing the former to dissociate the former from the pipe formed. The applicator may then be clamped to the pipe and moved in a forward-to-rear direction relative to the former to assist in at least partially removing the pipe from the former, while the applicator and the former are moved along a surface, preferably by the carriage. Once a continuous length of pipe has been formed, it may not be necessary to have the applicator assist in removing pipe from the former, as the forward motion of the carriage and the drag of the already formed continuous length of pipe may instead assist in removing pipe from the former.

The method may further include repeating said applying and said moving until a desired length of pipe is formed.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is an illustration showing a side view of a pipe forming assembly according to an embodiment of the present invention;

FIG. 2 is an illustration showing an end view of the pipe forming assembly shown in FIG. 1

FIG. 3 is an illustration showing a side view of a pipe forming assembly according to another embodiment of the present invention;

FIG. 4 is an illustration of a pipe forming assembly according to another embodiment of the present invention in which the pipe forming assembly is capable of transitioning between horizontal and vertical operating positions; and

FIG. 5 is an illustration of part of the pipe forming assembly shown in FIG. 4 in a vertical operating position.

### DETAILED DESCRIPTION

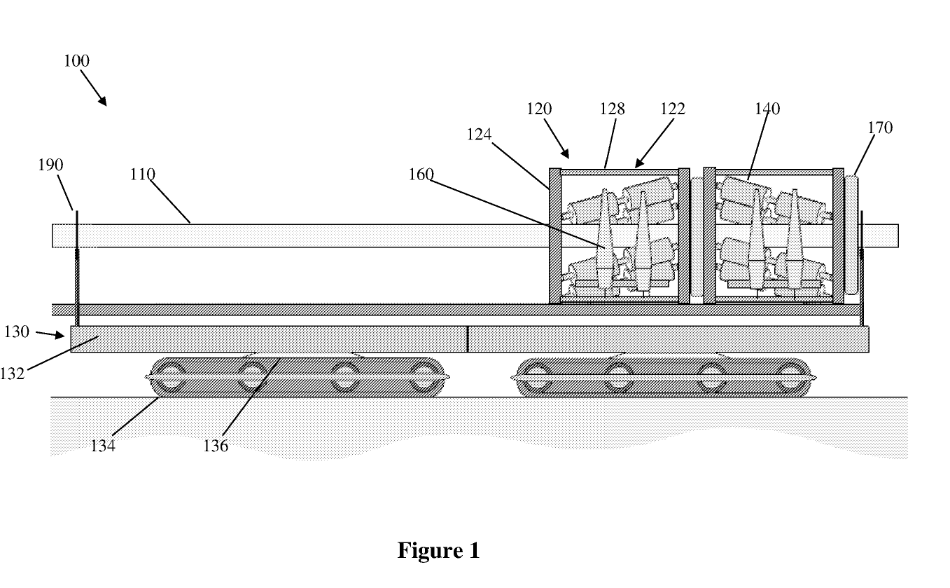

FIG. 1 shows a pipe forming assembly (100) according to an embodiment of the present invention. The pipe forming assembly (100) includes a former (110) and two winding apparatuses (120; i.e., applicators) for winding material about the former (110) to form the pipe. The winding apparatuses (120) are moveable relative to the former (110) while winding material to form the pipe. The assembly (100) further includes a carriage (130) for carrying the former (110) and the winding apparatuses (120) along a surface when forming a continuous length of pipe with the winding apparatuses (120).

The material is a fibrous material, such as, e.g., glass fibre, that has been pre-impregnated with resin (i.e., a thermosetting composition) such that it solidifies to form pipe once wound about the former (110) and allowed to cure.

Referring to FIG. 1, each winding apparatus (120) includes a frame (122; i.e., a roller support) for supporting rollers (140) and orbiting the rollers (140) about the former (110). The frame (122) includes opposed end frame members (124) joined together by one or more cross frame members (128). The end frame members (124) encircle the former (110) and are configured to rotate about the former (110). The rollers (140) extend between the end frame members (124). In use, each roller (140) is configured to wind material about the former (110) as the frame (122) rotates about the former (110) causing the rollers (140) to orbit the former (110). The frame (122) is mechanically driven to rotate about the former (110) and can rotate about the former (110) in either a clockwise or anti-clockwise direction.

The rollers (140) are arranged in the frame (122) at an adjustable angle relative to the former (110). The angle of the rollers (140) relative to the former (110) being mechanically adjustable even while the rollers (140) orbit the former (110).

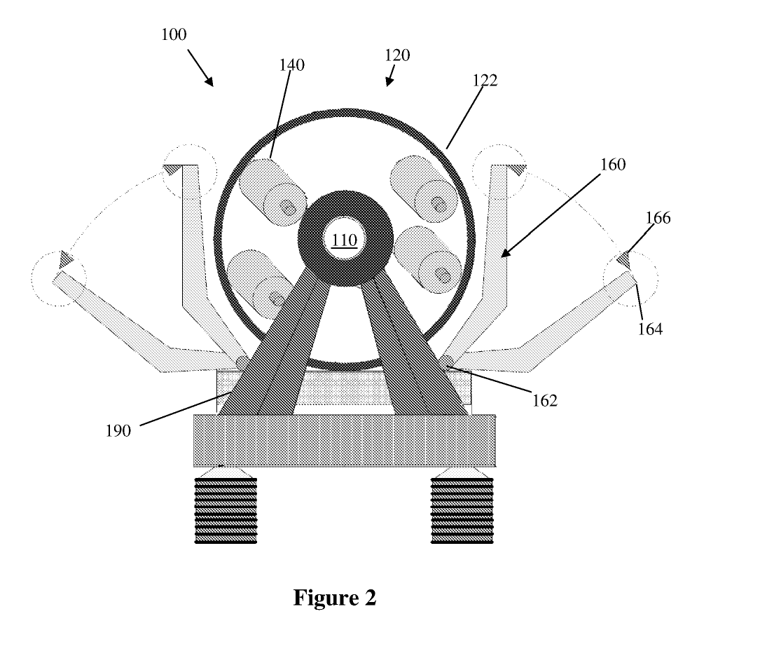

Each roller (140) is a feed roller containing pre-impregnated material to be wound about the former (110). The rollers (140) are releasably coupled to the frame (122) to allow each roller (140) to be replaced once exhausted of material. The assembly further includes two loading arms (160) on opposed sides of each winding apparatus (120) for replacing the rollers (140) as they are exhausted of material. The loading arms (160) will be described in detail below with reference to FIG. 2.

The former (110), about which the material is wound to form the pipe, has a circular cross-section and an adjustable circumference to allow pipe of differing diameters to be formed, and to assist in separating the former (110) from freshly formed pipe. To adjust the circumference, the former (110) includes segment having a triangular cross-section that is moveable in a lateral direction relative to a remainder of the former (110). In use, movement of the segment inwards relative to the remainder of the former (110) decreases the circumference. Conversely, movement of the segment outwards relative to the remainder of the former (110) increases the circumference.

As shown, the carriage (130) includes a platform (132) upon which the former (110) and the winding apparatuses (120) rest and along which the apparatuses (120) move while winding material about the former (110). The carriage (130) includes tracks (134) for propelling the assembly (110) along a surface and a self-levelling suspension system (136) located between the platform (132) and the tracks (134) to assist in stabilizing the assembly (100) as it moves along a surface, particularly a rough or uneven surface.

The former (110) is supported on the carriage (130) by former supports (190) located at either end of the carriage (130).

The winding apparatuses (120) move along the carriage (130) relative to the former (110) by way of a rack and pinion system. The carriage (130) includes one or more racks of the rack and pinion system located on an upper surface of the carriage (130) and extending longitudinally along a length of the carriage (130) atop the platform (132) of the carriage (130). The base of the frame (122) of each winding apparatus (120) includes corresponding pinions of the rack and pinion system, each pinion configured to engage with the racks for moving the apparatus (120) relative to the carriage (130) and the former (110). The pinions are mechanically driven to move the apparatuses (120) along the carriage (130) relative to the former (110).

Each winding apparatus (120) further includes a mechanical clamp (170) for temporarily clamping the apparatus (120) to recently formed pipe to assist in removing the pipe from the former (110).

A microwave, ultraviolet (“UV”) light or infrared emitting unit (i.e., the curing unit) is located within the former (110). The microwave, UV light or infrared emitting unit cures freshly wound material about the former (110) hardening the material to form pipe.

Referring to FIG. 2, the loading arms (160) are located on either side of each winding apparatus (120).

Each loading arm (160) has a first end (162) pivotally mounted to the frame (122) of the winding apparatus (120) at a location at or near a base of the frame (122), and a second end (164) pivotable between raised and lowered positions relative to the frame (122), as indicated by the arrows. The second end (164) includes a gripping unit (166) for gripping and releasing rollers (140).

In use, each loading arm (160) is able to move to a raised position to grip and remove an exhausted roller (140). The loading arm (160) then moves to a lowered position to exchange the exhausted roller (140) for a replacement roller (140) before moving back to the raised position to fit the replacement roller (140) to the frame (122).

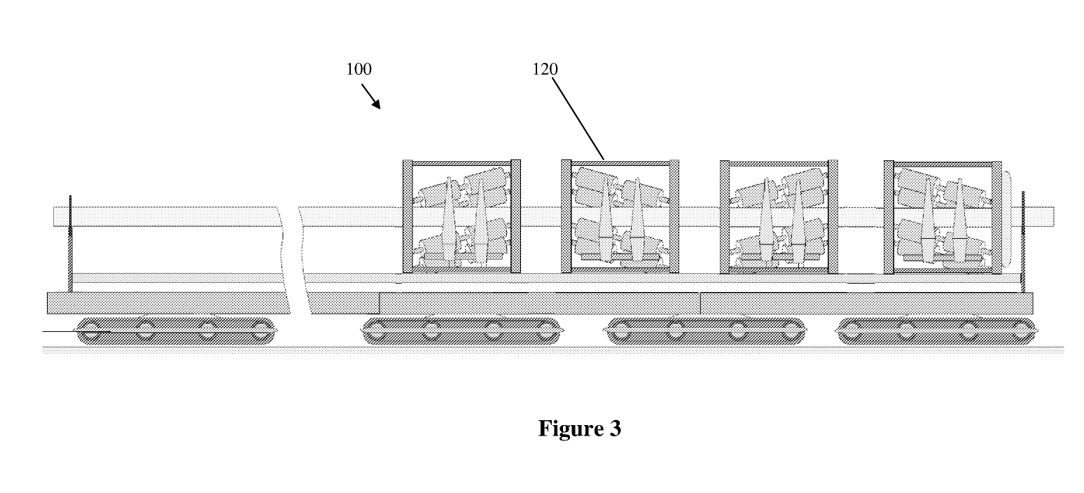

FIG. 3 shows another embodiment of the invention in which the assembly (100) includes four winding apparatuses (120) each configured to independently wind material about the former (110) and be moveable relative to the former (110) while winding material to form the pipe.

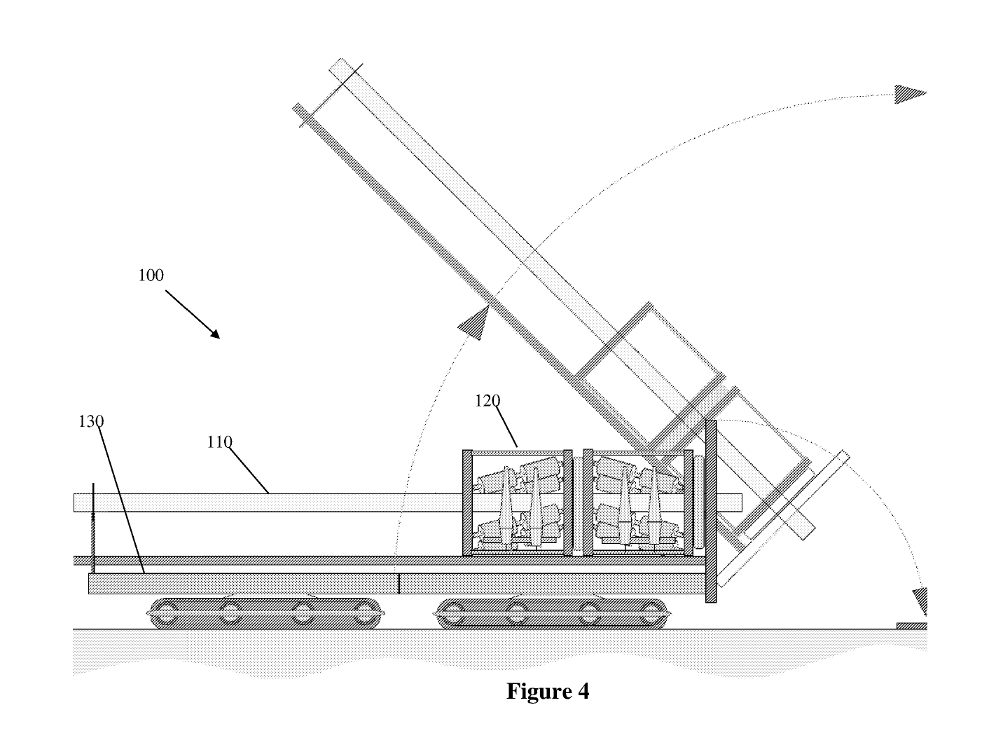

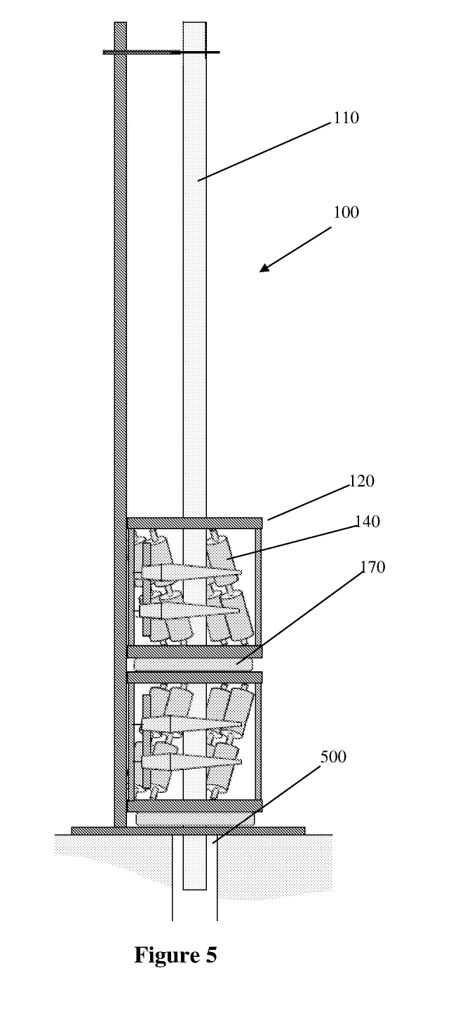

FIGS. 4 and 5 show another embodiment of the invention in which the assembly (100) is capable of transitioning between horizontal and vertical operating positions.

Referring to FIG. 4, a portion of the carriage (130) including the racks along which the winding apparatuses (120) move relative to the former is pivotally coupled to a remaining portion of the carriage (130) at one end of the carriage (130). The opposed second end of the carriage (130) includes a ram (not shown) for moving the portion of the carriage together with the former (110) and winding apparatuses (120) between the horizontal and vertical operating positions.

FIG. 5 shows part of the assembly (100) shown in FIG. 4 in a vertical operating position.

As shown, in the vertical operation position, the assembly (100) is able to form and insert freshly formed pipe directly into a bore hole (500).

A method of forming pipe with the assembly (100) as shown in FIG. 1 will now be described in detail.

As an initial step, each winding apparatus (120) is fully loaded with rollers (140) containing pre-impregnated material via the loading arms (160). Material from each roller (140) is then fastened to the former (110) to ensure material is drawn from the rollers (140) once the frames (122) of the winding apparatuses (120) rotate about the former (110) causing the rollers (140) to orbit the former (110).

The winding apparatuses (120) then commence pipe formation by winding material about the former (110) while moving in a common direction along the length of the former (110).

Depending on the type of pipe to be formed, each winding apparatus (120) can be loaded with rollers (140) containing the same type of pre-impregnated material or different types of pre-impregnated materials. Similarly, the winding apparatuses (120) can be configured to wind material about the former (110) in a same direction or in opposite directions.

For example, if loaded with the same type of material, the winding apparatuses (120) can be configured to wind material about the former (110) in a single direction to hasten pipe formation with each winding apparatus (120) winding material about and along a portion of the former (110) to collaboratively form a length of pipe. The material wound about the former (110) by a trailing winding apparatus (120) will at least partially overlap the material wound about the former (110) by a leading winding apparatus (120) to join the portions together.

Conversely, the winding apparatuses (120) can be configured to wind the same material about the former (110) in opposite directions to increase the crush strength of the pipe formed. Depending on the desired density and/or thickness, the winding apparatuses (120) can be configured to make repeat passes along the length of the former (110).

If loaded with different types of material, the winding apparatuses (120) can be configured to form pipe with a liner or a coating.

For example if forming pipe with a liner, a leading winding apparatus (120) is loaded with rollers (140) containing the lining material and a trailing winding apparatus (120) is loaded with rollers (140) containing the pipe forming material. The leading winding apparatus (120) can then form the liner by winding the lining material about the former (110) and the trailing winding apparatus (120) can form the pipe over the liner by winding the pipe forming material over the top of the lining material.

If forming pipe with a coating, the leading winding apparatus (120) is loaded with rollers (140) containing the pipe forming material and the trailing winding apparatus (120) is loaded with rollers (140) containing a coating material.

Once material is wound about the former (110) to a desired density and/or thickness, the winding apparatuses (120) move to a leading end of the former (110) and pause to allow the microwave, UV light or infrared emitting unit to cure the material hardening the material to form pipe.

Once cured, the former (110) dissociates from the pipe by decreasing in circumference and the carriage (130) moves the former (110) and the winding apparatuses forward to separate the former (110) from the pipe. If a desired length of pipe has been reached, the former (110) is moved clear of the pipe. Otherwise, if further pipe forming is desired, the former (110) is moved almost clear of the pipe leaving a small overlap between the former (110) and the pipe to allow the formation of a continuous length of pipe.

In some scenarios, the winding apparatuses (120) can temporarily clamp the pipe with their respective mechanical clamps (170) and move towards a trailing end of the former (110) to assist in removing the pipe from the former (110).

A method of forming pipe with the assembly (100) as shown in FIG. 5 is now described in detail.

Once the assembly (100) is in place, pipe formation commences by the winding apparatuses (120) winding material about the former (110) while moving in a common direction along the former (110).

As previously described, each winding apparatus (120) can be loaded with rollers (140) containing the same type of pre-impregnated material or different types of pre-impregnated materials to form pipe with a liner or coating. Similarly, the winding apparatuses (120) can be configured to wind material about the former (110) in a same direction or in opposite directions to vary the strength and/or speed with which pipe is formed.

Once material is wound about the former (110) to a desired density and/or thickness, the winding apparatuses (120) move to an upper end of the former (110) and pause to allow the microwave, UV light or infrared emitting unit to cure the material hardening the material to form the pipe.

Once cured, the winding apparatuses (120) temporarily clamp the pipe with their respective mechanical clamps (170). The former (110) then dissociates from the pipe by decreasing in circumference and the winding apparatuses (120) lower the pipe into the bore hole (500) by moving to a lower end of the former (110) while being temporarily clamped to the pipe.

If a desired length of pipe has been reached, the former (110) is moved clear of the pipe by the winding apparatuses (120) and the mechanical clamps (170) are disengaged.

If further pipe forming is desired, the winding apparatuses (120) move the pipe almost clear of the former (110) leaving a small overlap between the former (110) and the pipe to allow the formation of a continuous length of pipe. The former (110) then expands to its initial circumference, the mechanical clamps (170) of the winding apparatuses (120) disengage and the winding apparatuses (120) re-commence winding material about the former (110).

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A pipe forming assembly for forming a continuous length of pipe including:
a former;
at least two winding apparatuses for winding material about the former to form the pipe; and
a carriage for carrying the former and the at least two winding apparatuses along a surface while winding the material about the former for forming the continuous length of pipe,
wherein the at least two winding apparatuses are each moveable at least partially along a length of the former independently of the carriage while winding the material about the former.

2. The pipe forming assembly of claim 1, wherein the at least two winding apparatuses are configured to rotate in the same direction about the former.

3. The pipe forming assembly of claim 1, wherein the at least two winding apparatuses are configured to rotate in opposite directions about the former.

4. The pipe forming assembly of claim 1, wherein the material is a fibrous material that solidifies once impregnated with a thermosetting composition.

5. The pipe forming assembly of claim 4, wherein the material is a triaxial or quadraxial fibrous material.

6. The pipe forming assembly of claim 4, wherein the material is pre-impregnated with the thermosetting composition.

7. The pipe forming assembly of claim 1, wherein each winding apparatus includes a plurality of rollers and a roller support for supporting the plurality of rollers and orbiting the plurality of rollers about the former.

8. The pipe forming assembly of claim 7, wherein the roller support is mechanically driven about the former.

9. The pipe forming assembly of claim 7, wherein each roller of the plurality of rollers is a feed roller configured to independently wind the material about the former under tension.

10. The pipe forming assembly of claim 7, wherein each roller of the plurality of roller is releasably coupled to the roller support.

11. The pipe forming assembly of claim 7, wherein an angle of each roller of the plurality of rollers is adjustable to achieve a desired wrap angle.

12. The assembly of claim 7, further including a loading arm for replacing a roller on the roller support when it is exhausted of material with a replacement roller.

13. The assembly of claim 1, wherein the former has an adjustable circumference to thereby assist in forming pipe of differing diameters and to at least partially assist in dissociating the former from a portion of pipe once cured.

14. The assembly of claim 1, wherein the former is supported on the carriage by one or more former supports.

15. The assembly of claim 14, wherein each former support is releasably connectable to the former.

16. The assembly of claim 1, wherein the carriage includes rail and a base of each winding apparatus includes one or more wheels or rollers for moving along the rail and thereby moving the winding apparatus along the carriage relative to the former.

17. The assembly of claim 1, wherein the carriage includes one or more racks and a base of each winding apparatus includes one or more pinions for moving along the racks and thereby moving the winding apparatus along the carriage relative to the former.

18. The assembly of claim 1, wherein each winding apparatus further includes at least one clamp for temporarily clamping the winding apparatus to the pipe formed about the former to at least partially assist in dissociating and/or removing the pipe from the former.

19. A pipe forming assembly including at least two of the pipe forming assembly of claim 1 arranged in series, each pipe forming assembly being configured to wind material about the former.

20. A method of forming a continuous length of pipe, said method including:
winding material with at least two winding apparatuses about a former and moving the at least two winding apparatuses at least partially along a length of the former while winding the material about the former to form the pipe; and
moving the at least two winding apparatuses and the former along a surface while winding the material about the former to form the continuous length of pipe.
